(19) United States
(12) Patent Application Publication
(10) Pub. No.: US 2026/0115945 A1
(43) Pub. Date: Apr. 30, 2026

(54) CUTTING UNIT, SHAVER HEAD, AND ELECTRIC SHAVER

(71) Applicant: Shenzhen Soocas Technology Co., Ltd., Shenzhen (CN)

(72) Inventors: Dong HUANG, Shenzhen (CN); Zhoujian LI, Shenzhen (CN); Yaqiang WEI, Shenzhen (CN)

(73) Assignee: Shenzhen Soocas Technology Co., Ltd., Shenzhen (CN)

(21) Appl. No.: 19/430,516

(22) Filed: Dec. 23, 2025

Related U.S. Application Data
(63) Continuation of application No. PCT/CN2025/114271, filed on Aug. 13, 2025.

(30) Foreign Application Priority Data
Oct. 14, 2024 (CN) 2024114337175

(51) Int. Cl. B26B 19/14

(52) U.S. Cl. CPC B26B 19/141

(57) ABSTRACT

Embodiments of the present disclosure disclose a cutting unit, a shaver head, and an electric shaver. The cutting unit is used in a shaver, and includes a support member having a rotation axis and cutting blades provided with cutting edges. The support member carries support legs in the cutting blades. Each cutting blade has a direction of movement during the rotation of the cutting unit around the rotation axis. Each of the cutting edges includes a first cutting edge and a second cutting edge. A curvature of the first cutting edge is greater than or equal to a curvature of the second cutting edge, and a distance from the first cutting edge to the rotation axis is greater than or equal to a distance from the second cutting edge to the rotation axis.

### CROSSREFERENCE TO RELATED APPLICATION

This application is a continuation of International Application No. PCT/CN2025/114271, filed on August 13, 2025, which claims priority to Chinese Patent Application No.2024114337175 titled "CUTTING UNIT, SHAVER HEAD, AND ELECTRIC SHAVER" and filed to the State Patent Intellectual Property Office on October 14, 2024, the entire contents of which are incorporated herein by reference.

### TECHNICAL FIELD

The present disclosure relates to the field of shaver technology, and more particularly, to a cutting unit, a shaver head, and an electric shaver.

### BACKGROUND

A shaving unit of an electric shaver includes a blade and a shaver foil, and shaving is implemented by using the blade to cut hair entering the shaver foil. During shaving, beards frequently enter a cutting area of beards from a distal end of a shaver foil slot. Conventional shavers typically use straight blades in combination with straight slots for cutting. When entering the cutting area, the beards may be pushed out of the shaver foil slot, resulting in shaving failure, pulling sensations, or ineffective cutting, thereby adversely affecting the shaving efficiency.

### SUMMARY

Embodiments of the present disclosure provide a cutting unit, a shaver head, and an electric shaver.

To solve the above technical problem, the embodiments of the present disclosure are implemented as below.

The embodiments of the present disclosure provide a cutting unit, which is used in a shaver. The cutting unit includes a support member having a rotation axis and cutting blades provided with cutting edges. The support member carries support legs in the cutting blades, and each of the cutting blades has a direction of movement during rotation of the cutting unit around the rotation axis.

Each of the cutting edges includes a first cutting edge and a second cutting edge. A curvature of the first cutting edge is greater than or equal to a curvature of the second cutting edge, and a distance from the first cutting edge to the rotation axis is greater than or equal to a distance from the second cutting edge to the rotation axis.

Alternatively, in the direction of movement of the cutting unit, the first cutting edge is arranged in front of the second cutting edge.

Alternatively, the curvature of the first cutting edge ranges from 0 to 6.

Alternatively, the curvature of the second cutting edge ranges from 0 to 2.

Alternatively, the curvature of the first cutting edge is different from the curvature of the second cutting edge; and/or, the first cutting edge and the second cutting edge are arranged asymmetrically.

Alternatively, a ratio of a projection length of the first cutting edge on a horizontal plane to a projection length of the second cutting edge on the horizontal plane is 0.618+K, -0.2≤K≤0.2.

Alternatively, each of the cutting blades is provided with a plurality of first cutters, and the plurality of first cutters are arranged on the support member at intervals in a circumferential direction of the support member.

Alternatively, each of the cutting blades is further provided with a plurality of second cutters, and the plurality of second cutters are arranged on the support member at intervals in the circumferential direction of the support member, where the plurality of second cutters are positioned on one side of each of the plurality of first cutters adjacent to the rotation axis.

The shaver head provided by the embodiments of the present disclosure includes a shaver foil used in a shaver and the cutting unit as mentioned above, where the shaver foil includes an annular shaving track concentrically arranged around the rotation axis to mate with a cutting edge of the cutting unit. The annular shaving track is provided with an inner circumferential side surface, an outer circumferential side surface, and a beard inlet slot having a front edge and a rear edge when observed in the direction of movement of the cutting unit, and the beard inlet slot extends on at least one of the inner circumferential side surface and the outer circumferential side surface.

Alternatively, the beard inlet slot is S-shaped, V-shaped, U-shaped, or arc-shaped.

The electric shaver provided by the embodiments of the present disclosure includes a handheld portion and the shaver head as mentioned above, where the shaver head is arranged on the handheld portion.

### BRIEF DESCRIPTION OF THE DRAWINGS

To describe the technical solutions of the embodiments of the present disclosure or those of the prior art more clearly, the accompanying drawings required for describing the embodiments or the prior art will be briefly introduced below. Apparently, the accompanying drawings in the following description are merely some embodiments of the present application. To those of ordinary skills in the art, other accompanying drawings may also be derived from these accompanying drawings without creative efforts.

FIG. 1 is a schematic structural diagram of a cutting blade according to an embodiment of the present disclosure;

FIG. 2 is a schematic structural diagram of a shaver foil according to an embodiment of the present disclosure;

FIG. 3 is a schematic structural diagram of a cutting unit according to an embodiment of the present disclosure;

FIG. 4 is a front view of a cutting unit according to an embodiment of the present disclosure;

FIG. 5 is a top view of a cutting unit according to an embodiment of the present disclosure;

FIG. 6 is a partial enlarged view of a position A in FIG. 5 according to an embodiment of the present disclosure;

FIG. 7 is a top view of a cutting unit according to an embodiment of the present disclosure;

FIG. 8 is a partial enlarged view of a position B in FIG. 7 according to an embodiment of the present disclosure;

FIG. 9 is a schematic diagram of shape comparison of a cutting edge according to an embodiment of the present disclosure;

FIG. 10 is a schematic diagram of a projection length of a cutting edge according to an embodiment of the present disclosure;

FIG. 11 is a schematic structural diagram of a shaver head according to an embodiment of the present disclosure;

FIG. 12 is a top view of a shaver head according to an embodiment of the present disclosure;

FIG. 13 is a cross-sectional view of a shaver head according to an embodiment of the present disclosure;

FIG. 14 is a schematic structural diagram of a shaver foil according to an embodiment of the present disclosure;

FIG. 15 is a schematic structural diagram of a shaver head with an S-shaped beard inlet slot according to an embodiment of the present disclosure;

FIG. 16 is a partial enlarged view of a position C in FIG. 15 according to an embodiment of the present disclosure;

FIG. 17 is a schematic structural diagram of an arc-shaped beard inlet slot according to an embodiment of the present disclosure; and

FIG. 18 is a schematic structural diagram of an electric shaver according to an embodiment of the present disclosure.

Reference numerals in the accompanying drawings:

straight-edge cutting blade 1; straight-slot shaver foil 2; cutting unit 3; support member 31; cutting blade 32; first cutting edge 321; second cutting edge 322; support leg 33; fixed base 34; shaver foil 4; annular shaving track 41; inner circumferential side surface 411; outer circumferential side surface 412; beard inlet slot 413; strip-shaped rib 414; rib body 415; first fixing foot 416; second fixing foot 417; shaver foil cutting edge 42; shaver head 5; shaver head housing 51; and handheld portion 6.

### DETAILED DESCRIPTION

To make the objectives, technical solutions, and advantages of one or more embodiments of the present disclosure clearer, the technical solutions in the one or more embodiments of the present disclosure will be clearly and completely described below with reference to the specific embodiments and the corresponding accompanying drawings in the present disclosure. It is apparent that the embodiments as described are merely some, rather than all, of the embodiments of the present disclosure. All other embodiments obtained by those of ordinary skill in the art based on the embodiments in the present disclosure without creative efforts should fall within the scope of the one or more embodiments of the present disclosure.

The technical solutions provided by the embodiments of the present disclosure are described in detail below with reference to the accompanying drawings.

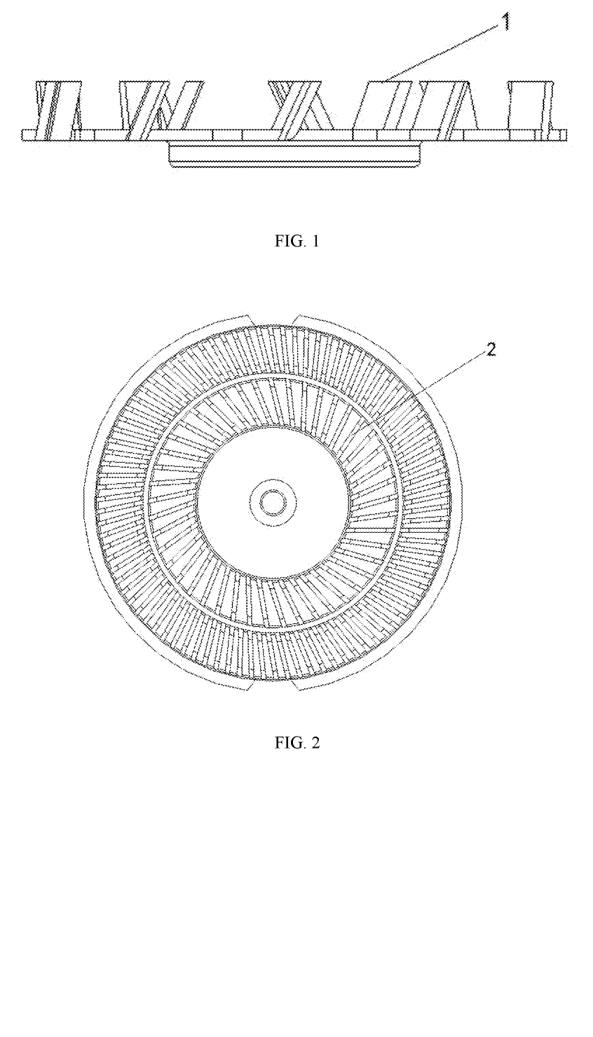

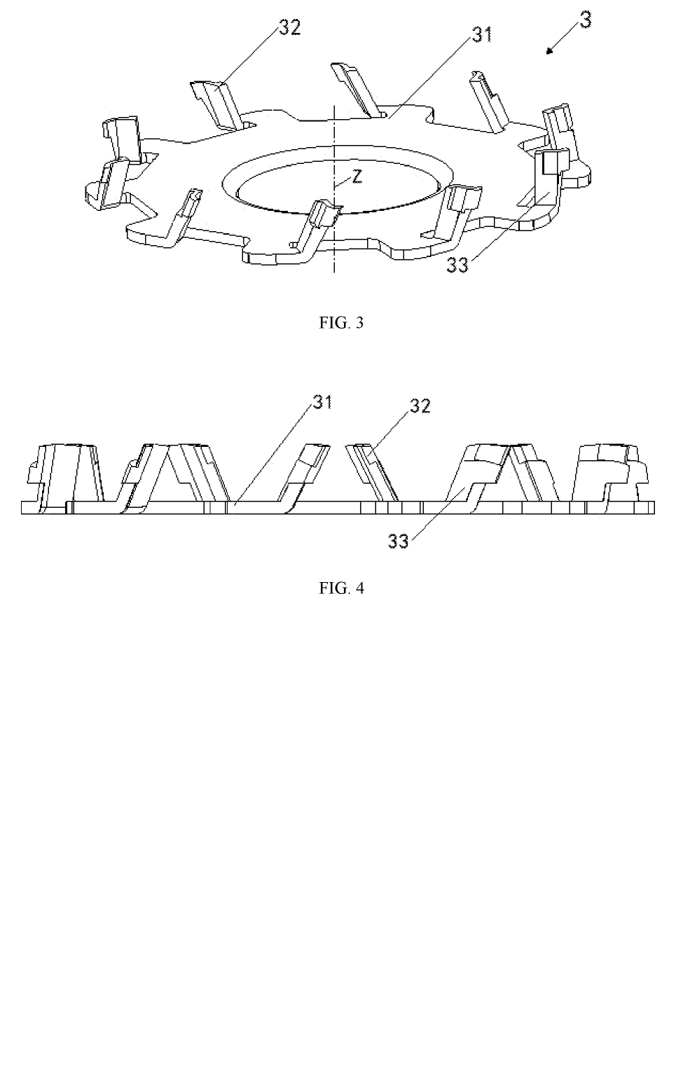

A shaver typically performs shaving by using cutting blades to cut beards entering a shaver foil. In practical applications, the shaver typically uses a straight-edge cutting blade and a straight-slot shaver foil. FIG. 1 is a schematic structural diagram of a cutting blade according to embodiments of the present disclosure, and FIG. 2 is a schematic structural diagram of the shaver foil according to the embodiments of the present disclosure. Referring to FIG. 1, as can be seen, the cutting blade of the shaver is a straight-edge cutting blade 1, and referring to FIG. 2, as can be seen, the shaver foil of the shaver is a straight-slot shaver foil 2. Under the action of the straight-edge cutting blade and the straight-slot shaver foil, when entering a cutting area of the shaver, the beards may be pushed out of the shaver foil slot, and when a user uses the shaver to shave the beards back and forth, pulling sensations on the beards may occur, thus adversely affecting the shaving efficiency.

To solve the defects in the existing technology, this solution provides the following embodiments.

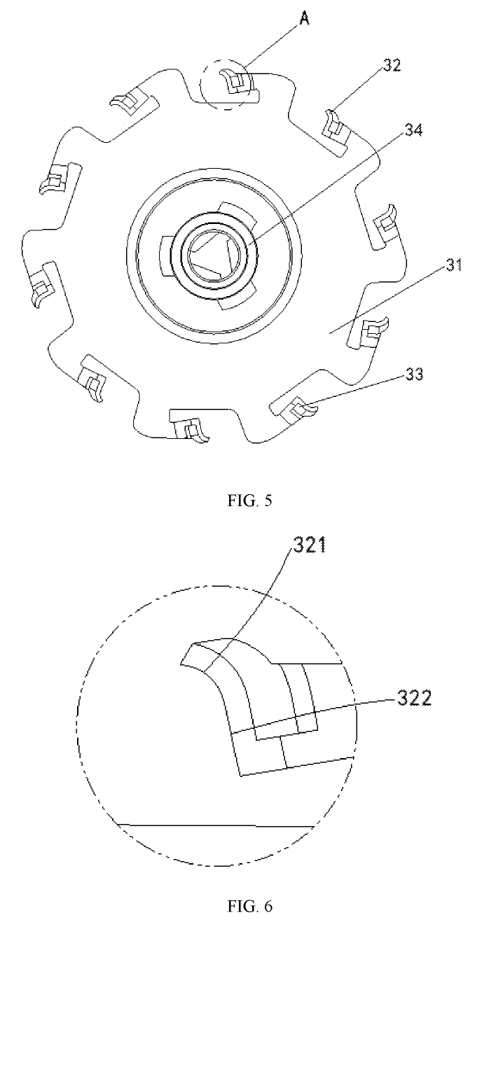

FIG. 3 is a structural diagram of a cutting unit according to the embodiments of the present disclosure, and FIG. 4 is a front view of a cutting unit according to the embodiments of the present disclosure. As shown in FIG. 3 and FIG. 4, a cutting unit 3 in the embodiments of the present disclosure is used in the shaver. The cutting unit 3 may include a support member 31 having a rotation axis Z and cutting blades 32 provided with cutting edges. The support member 31 is used for carrying support legs 33 in the cutting blades 32. Each cutting blade 32 has a direction of movement during the rotation of the cutting unit 3 around the rotation axis Z.

FIG. 5 is a top view of a cutting unit according to the embodiments of the present disclosure. As shown in FIG. 5, the cutting unit 3 in the embodiments of the present disclosure may also include a fixed base 34 arranged coaxially with the support member 31. The fixed base 34 may be used for coupling with an external driving shaft. The external driving shaft may drive the cutting unit 3 to rotate by driving the fixed base 34.

FIG. 6 is a partial enlarged view of a position A in FIG. 5 according to the embodiments of the present disclosure. As shown in FIG. 6, each of the cutting edges of the cutting blades 32 includes a first cutting edge 321 and a second cutting edge 322, and a curvature of the first cutting edge 321 may be greater than or equal to a curvature of the second cutting edge 322. Referring to FIG. 3, in the embodiments of the present disclosure, a distance from the first cutting edge 321 to the rotation axis Z may be greater than or equal to a distance from the second cutting edge 322 to the rotation axis Z.

In the embodiments of the present disclosure, the curvature of the first cutting edge 321 of each of the cutting edges is set to be greater than or equal to the curvature of the second cutting edge 322, and the distance from the first cutting edge 321 to the rotation axis Z is set to be greater than or equal to the distance from the second cutting edge 322 to the rotation axis. In this way, after entering the cutting area, the beards may be gathered by the first cutting edge 321, thereby avoiding the beards from being pushed out of the beard inlet slot of the shaver foil; and when the user uses the shaver to shave the beards back and forth, pulling sensations on the beards cannot occur, thereby improving shaving experience for the user. In addition, after the beards are gathered, the first cutting edge 321 may be used in combination with the second cutting edge 322 for effective cutting, thus achieving higher shaving efficiency.

In one specific embodiment, each of the cutting edges of the cutting blades 32 may be provided with a protrusion protruding in an opposite direction of the direction of movement of the cutting unit 3. Due to the presence of the protrusion, the cutting edges of the cutting blades 32 may also be enabled to gather the beards, avoiding the pulling sensations on the beards and improving the shaving efficiency.

Specifically, both the first cutting edge 321 and the second cutting edge 322 of each of the cutting edges may be straight cutting edges, and the straight first cutting edge 321 and the straight second cutting edge 322 may form a preset angle.

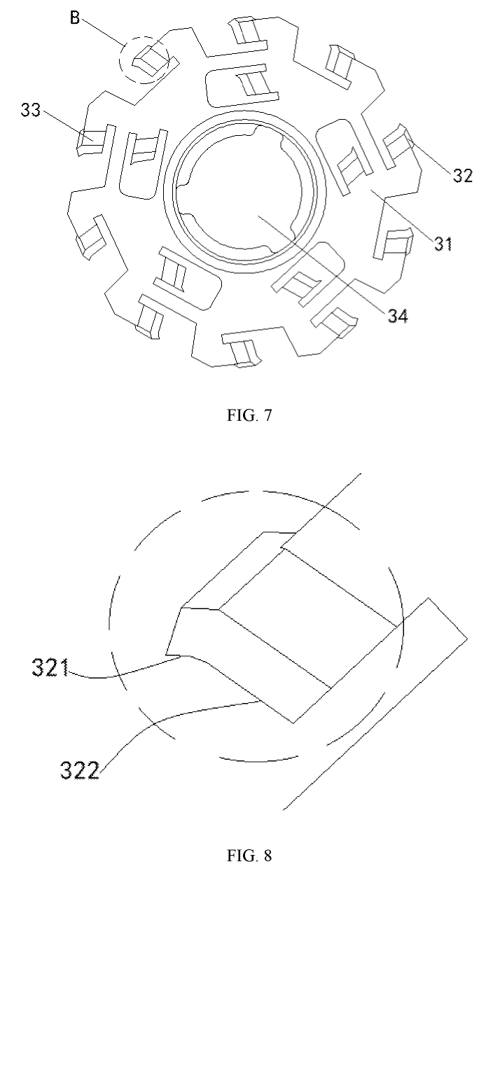

FIG. 7 is a top view of a cutting unit according to the embodiments of the present disclosure, and FIG. 8 is a partial enlarged view of a position B in FIG. 7 according to the embodiments of the present disclosure. As shown in FIG. 7 and FIG. 8, both the first cutting edge 321 and the second cutting edge 322 may be the straight cutting edges.

It is to be understood that one of the first cutting edge 321 and the second cutting edge 322 may be a curvilinear cutting edge, and the other one thereof may be the straight cutting edge. In this case, the preset angle is formed between a cutting line passing through a curve starting point and a curve ending point of the curvilinear cutting edge and a straight line of the straight cutting edge. Alternatively, both the first cutting edge 321 and the second cutting edge 322 are the curvilinear cutting edges. For example, the first cutting edge 321 is a first curvilinear cutting edge, and the second cutting edge 322 is a second curvilinear cutting edge. In this case, the preset angle is formed between a cutting line passing through a curve starting point and a curve ending point of the first curvilinear cutting edge and a cutting line passing through a curve starting point and a curve ending point of the second curvilinear cutting edge.

In the embodiments of the present disclosure, the preset angle may be an angle greater than zero.

To further improve effects of the first cutting edge 321 in gathering the beards, in the embodiments of the present disclosure, in the direction of movement of the cutting unit 3, the first cutting edge 321 of any one cutting blade 32 may be arranged in front of the second cutting edge 322 of the cutting blade 32.

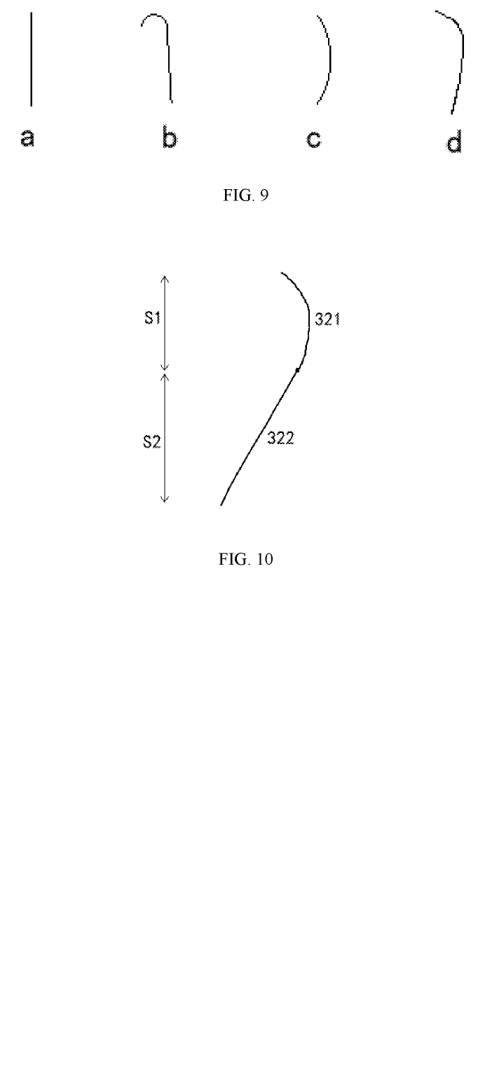

FIG. 9 is a schematic diagram of shape comparison of a cutting edge according to the embodiments of the present disclosure. In the embodiments of the present disclosure, a in FIG. 9 is called the straight cutting edge, b in FIG. 9 is called a barb-shaped cutting edge, c in FIG. 9 is called an arc-shaped cutting edge, and d in FIG. 9 is called a sickle-shaped cutting edge. The straight cutting edge a is a cutting edge in practical applications. The straight cutting edge a may be used as a whole to cut the beards, with a larger effective cutting area. However, because the straight cutting edge a is straight, without the beard gathering effects, the beards are easily pushed out of the straight cutting edge a, resulting in lower shaving efficiency. For the barb-shaped cutting edge b, the first cutting edge of the barb-shaped cutting edge b has the beard gathering effects, but is not responsible for beard cutting, resulting in a smaller effective cutting area and lower shaving efficiency. For the arc-shaped cutting edge c, although the arc-shaped cutting edge c as a whole may have the beard gathering effects, when the beards are gathered, the beards may be gathered to a middle of the arc-shaped cutting edge c. As a result, the effective cutting area is only the middle of the arc-shaped cutting edge c, that is, the effective cutting area is also smaller, resulting in lower shaving efficiency.

To improve the beard gathering effects compared to the straight cutting edge a, and to avoid the situation where the barb-shaped cutting edge b and the arc-shaped cutting edge c have smaller effective cutting areas, the sickle-shaped cutting edge d is provided in the embodiments of the present disclosure. The curvature of the first cutting edge of the sickle-shaped cutting edge d may range from 0 to 6. The curvature of the second cutting edge of the sickle-shaped cutting edge d may range from 0 to 2. Under the above curvature ranges, the first cutting edge of the sickle-shaped cutting edge d has the beard gathering effects, and the second cutting edge of the sickle-shaped cutting edge d has a larger effective cutting area, and thus the shaving efficiency is higher.

In the embodiments of the present disclosure, the curvature of the first cutting edge of the sickle-shaped cutting edge d ranges from 0 to 6, and specifically may be (0mm⁻¹, 6mm⁻¹). The curvature of the second cutting edge of the sickle-shaped cutting edge d ranges from 0 to 2, and specifically may be (0mm⁻¹, 2mm⁻¹). Preferably, the first cutting edge and/or the second cutting edge are curves. That is, the curvature of the first cutting edge is (0mm⁻¹, 6mm⁻¹), and/or the curvature of the second cutting edge is (0mm⁻¹, 2mm⁻¹).

To improve the beard gathering effects and the shaving efficiency of the cutting edges, the curvature of the first cutting edge 321 is different from the curvature of the second cutting edge 322; and/or, the first cutting edge 321 and the second cutting edge 322 are arranged asymmetrically.

Further, when a projection length of the first cutting edge 321 on a horizontal plane is larger, and a projection length of the second cutting edge 322 on the horizontal plane is smaller, the shaving efficiency may be adversely affected by the smaller effective cutting area of the second cutting edge 322. Whereas, when the projection length of the first cutting edge 321 on the horizontal plane is smaller, and the projection length of the second cutting edge 322 on the horizontal plane is larger, the shaving efficiency may be adversely affected by the poorer beard gathering effects of the first cutting edge 321. Therefore, to improve the shaving efficiency by increasing the effective cutting area with the beard gathering effects, a ratio of the projection length of the first cutting edge 321 on the horizontal plane to the projection length of the second cutting edge 322 on the horizontal plane is a preset value in the embodiments of the present disclosure.

FIG. 10 is a schematic diagram of a projection length of a cutting edge according to the embodiments of the present disclosure. As shown in FIG. 10, the projection length of the first cutting edge 321 on the horizontal plane may be S1, the projection length of the second cutting edge 322 on the horizontal plane may be S2, and the preset value is S1/S2, which may be 0.618+K, where -0.2≤K≤0.2.

In the embodiments of the present disclosure, to improve the shaving efficiency of the cutting unit 3, each of the cutting blades 32 may be provided with a plurality of first cutters, and the plurality of first cutters are arranged on the support member 31 at intervals in a circumferential direction of the support member 31.

To further improve the shaving efficiency of the cutting unit 3, each of the cutting blades 32 may be further provided with a plurality of second cutters, and the plurality of second cutters are arranged on the support member 31 at intervals in the circumferential direction of the support member 31. The second cutters may be positioned on one side of each of the first cutters adjacent to the rotation axis Z.

Based on the same idea, the embodiments of the present disclosure further provide a shaver head.

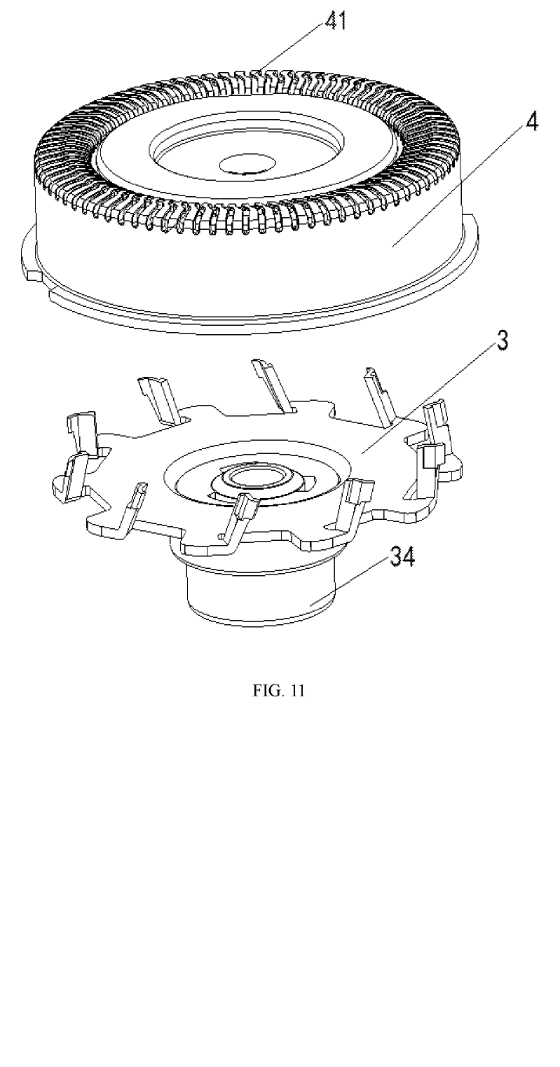

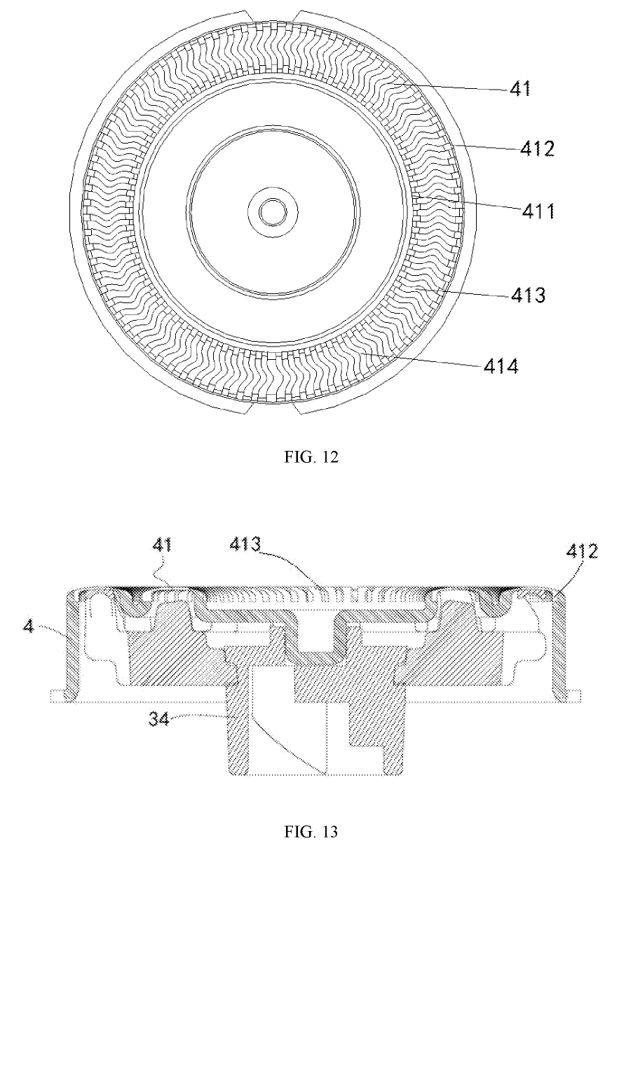

FIG. 11 is a schematic structural diagram of a shaver head according to the embodiments of the present disclosure. FIG. 12 is a top view of a shaver head according to the embodiments of the present disclosure. FIG. 13 is a cross-sectional view of a shaver head according to the embodiments of the present disclosure. As shown in FIG. 11 to FIG. 13, the shaver head in the embodiments of the present disclosure may include a shaver foil 4 used in a shaver and the above cutting unit 3, where the shaver foil 4 may be provided on the cutting unit 3. The shaver foil 4 may include an annular shaving track 41 concentrically arranged around the rotation axis Z to mate with the cutting edge of the cutting unit 3.

The annular shaving track 41 is provided with an inner circumferential side surface 411 and an outer circumferential side surface 412. The inner circumferential side surface 411 may be on one side of the annular shaving track 41 adjacent to the rotation axis Z of the support member 31. The outer circumferential side surface 412 may be on one side of the annular shaving track 41 distant from the rotation axis Z of the support member 31. The annular shaving track 41 is also provided with a beard inlet slot 413 having a front edge and a rear edge when observed in the direction of movement of the cutting unit 3, and the beard inlet slot 413 extends on at least one of the inner circumferential side surface 411 and the outer circumferential side surface 412.

Further, the annular shaving track 41 may include a plurality of strip-shaped ribs 414, and the beard inlet slot 413 may be arranged between two adjacent strip-shaped ribs 414.

In the embodiments of the present disclosure, the cutting edge of each of the cutting blades 32 may abut against the inner circumferential side surface 411 of the annular shaving track 41. When the shaver head is in use, the fixed base 34 of the cutting unit 3 may be coupled with an external driving shaft to drive the cutting unit 3 to rotate along the annular shaving track 41, and the beards may enter the shaver foil 4 from the beard inlet slot 413 and may be cut by the cutting blades 32 in the shaver foil 4.

In practical applications, each of the strip-shaped ribs is arranged between a top of the outer circumferential side surface and a top of the inner circumferential side surface of the annular shaving track. One end of the strip-shaped rib is connected to the top of the outer circumferential side surface of the annular shaving track, and the other end of the strip-shaped rib is connected to the top of the inner circumferential side surface of the annular shaving track. In this way, when entering the shaver foil from the outer circumferential side surface and the inner circumferential side surface, the beards are easily blocked by the two ends of the strip-shaped rib, thereby adversely adversely affecting the shaving efficiency.

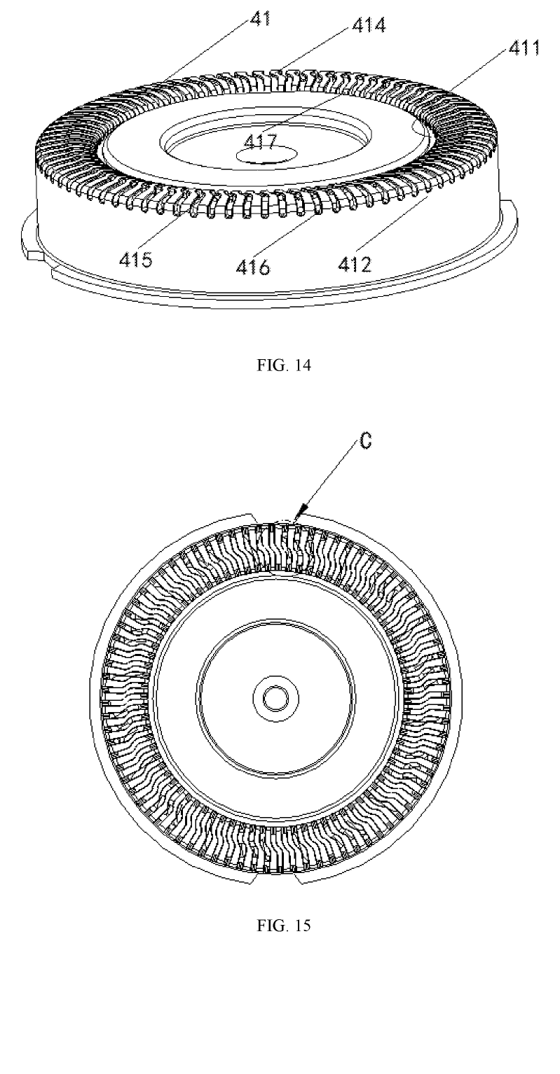

FIG. 14 is a schematic structural diagram of a shaver foil according to the embodiments of the present disclosure. As shown in FIG. 14, in the embodiments of the present disclosure, the strip-shaped rib 414 may include a rib body 415, and a first fixing foot 416 and a second fixing foot 417 positioned on two sides of the rib body. The first fixing foot 416 may be arranged on the outer circumferential side surface 412, and the second fixing foot 417 may be arranged on the inner circumferential side surface 411. Furthermore, the strip-shaped rib 414 may not block the beards entering the shaver foil 4, making it easier for the beards to enter the shaver foil 4 for cutting, thereby improving the shaving efficiency.

To improve the beard gathering effects and further improve the shaving efficiency, in the embodiments of the present disclosure, the beard inlet slot 413 of the shaver foil 4 may be provided with a protrusion protruding in the direction of movement of the cutting unit 3. The protrusion of the beard inlet slot 413 may be used in conjunction with the cutting edge of each of the cutting blades 32 to gather the beards, thereby improving the beard gathering effects.

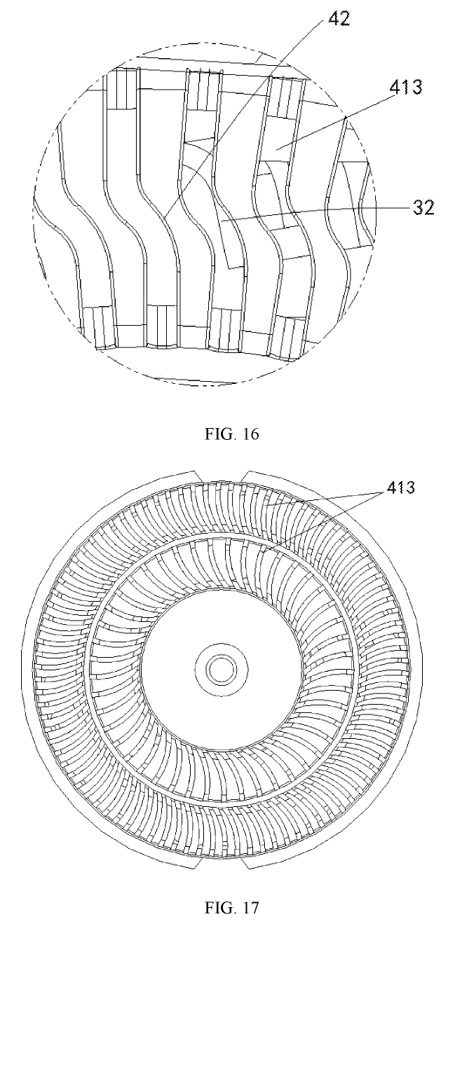

Specifically, FIG. 15 is a schematic structural diagram of a shaver head with an S-shaped beard inlet slot according to the embodiments of the present disclosure, and FIG. 16 is a partial enlarged view of a position C in FIG. 15 according to the embodiments of the present disclosure. As shown in FIG. 15 and FIG. 16, the beard inlet slot 413 may specifically be S-shaped in the embodiments of the present disclosure. Two sides of the beard inlet slot 413 may be provided with shaver foil cutting edges 42. After entering the shaver foil 4, the beards may be cut by the cutting blade 32 in conjunction with the shaver foil cutting edges 42.

FIG. 17 is a schematic structural diagram of an arc-shaped beard inlet slot according to embodiments of the present disclosure. As shown in FIG. 17, the beard inlet slot 413 may also be arc-shaped in the embodiments of the present disclosure. In the embodiments of the present disclosure, when each of the cutting blades 32 is provided with a plurality of first cutters and a plurality of second cutters, the shaver foil 4 may also be provided with the beard inlet slot 413 for shaving in conjunction with the first cutters and the second cutters.

Further, in the embodiments of the present disclosure, the beard inlet slot 413 may also be U-shaped, or V-shaped as shown in FIG. 12.

It is to be understood that the beard inlet slot 413 may also other shapes, which are not specifically limited herein.

Based on the same idea, the embodiments of the present disclosure also provide an electric shaver.

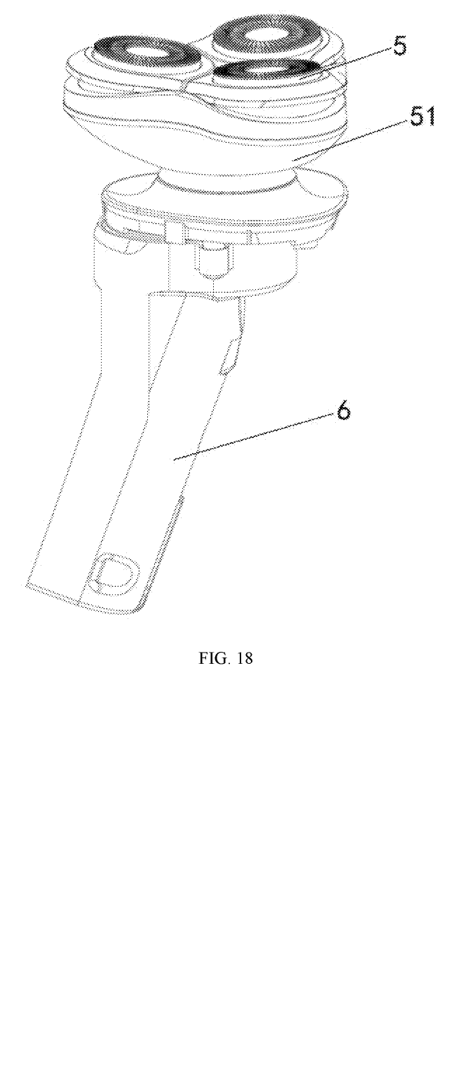

FIG. 18 is a schematic structural diagram of an electric shaver according to the embodiments of the present disclosure. As shown in FIG. 18, the electric shaver in the embodiments of the present disclosure includes a handheld portion 6 and the above shaver head 5. The shaver head 5 may be arranged on the handheld portion 6.

In the embodiments of the present disclosure, the shaver head 5 may be mounted on a shaver head housing 51, and thus the shaver head 5 may be arranged on the handheld portion 6 by means of the shaver head housing 51.

In the embodiments of the present disclosure, to save industrial costs, one shaver head 5 may be provided on the shaver head housing 51.

To improve the shaving efficiency, a plurality of shaver heads 5 may be provided on the shaver head housing 51. For example, two, three, or five shaver heads 5 may be provided, but are not limited thereto.

One embodiment of the present disclosure can achieve the following beneficial effects.

In the cutting unit, the shaver head, and the electric shaver provided by the embodiments of the present disclosure, by setting the curvature of the first cutting edge of each of the cutting edges to be greater than or equal to the curvature of the second cutting edge, and the distance from the first cutting edge to the rotation axis to be greater than or equal to the distance from the second cutting edge to the rotation axis, the first cutting edge can effectively gather beards, and can be used in combination with the second cutting edge for effective cutting, thereby avoiding the beards from being pushed out of the beard inlet slot of the shaver foil, and thus improving the shaving efficiency.

For convenience of description, spatially relative terms, such as “above”, “over”, “on an upper surface of”, “on” and the like, may be used herein to describe a spatial position relationship between one device or feature and other devices or features shown in the figures. It should be understood that the spatially relative terms are intended to encompass different orientations in use or operation other than the orientation of the device described in the figures. For example, if the device in the drawings is inverted, the device described as “above other devices or structures” or “over other devices or structures” will be oriented as “below other devices or structures” or “under other devices or structures”. Thus, the exemplary term “above” may include two orientations: “above” and “below”. The device may be otherwise oriented (rotated 90 degrees or at other orientations) and the spatially relative descriptors used herein interpreted accordingly.

It is to be noted that the terms used herein are only for the purpose of describing the specific embodiments, and are not intended to limit the exemplary embodiments according to the present disclosure. As used herein, the singular forms are intended to include the plural forms unless the context clearly dictates otherwise. In addition, it should be understood that when the terms "including" and/or "comprising" are used in this specification, they indicate the presence of features, steps, operations, devices, components, and/or combinations thereof.

It should be explained that in the specification, the claims and the foregoing accompanying drawings of the present application, a term (such as a first or a second……) is intended to separate between similar objects but is not intended to describe a specific sequence or precedence order. It is to be understood that data used like this may be interchangeable where appropriate, such that the embodiments of the present disclosure described herein may be implemented in sequences excluding those illustrated or described herein. Furthermore, terms such as “comprise”, “have” or other variants thereof are intended to cover a non-exclusive “comprise”, for example, processes, methods, systems, products or devices comprising a series of steps or units are not limited to these steps or units listed explicitly, but comprise other steps or units not listed explicitly, or other steps or units inherent to these processes, methods, systems, products or devices.

The above are merely preferred embodiments of the present disclosure and are not intended to limit the present disclosure. To those skilled in the art, the present disclosure may have various modifications and changes. All modifications, equivalent substitutions and improvements made within the spirit and principle of the present disclosure shall fall within the protection scope of the present disclosure.

What is claimed is:

1. A cutting unit, wherein the cutting unit is used in a shaver, and comprises a support member having a rotation axis and cutting blades provided with cutting edges; the support member carries support legs in the cutting blades; each of the cutting blades has a direction of movement during rotation of the cutting unit around the rotation axis; and
each of the cutting edges comprises a first cutting edge and a second cutting edge; a curvature of the first cutting edge is greater than or equal to a curvature of the second cutting edge, and a distance from the first cutting edge to the rotation axis is greater than or equal to a distance from the second cutting edge to the rotation axis.

2. The cutting unit according to claim 1, wherein in the direction of movement of the cutting unit, the first cutting edge is arranged in front of the second cutting edge.

3. The cutting unit according to claim 1, wherein the curvature of the first cutting edge ranges from 0 to 6.

4. The cutting unit according to claim 1, wherein the curvature of the second cutting edge ranges from 0 to 2.

5. The cutting unit according to claim 1, wherein the curvature of the first cutting edge is different from the curvature of the second cutting edge; and/or, the first cutting edge and the second cutting edge are arranged asymmetrically.

6. The cutting unit according to claim 1, wherein a ratio of a projection length of the first cutting edge on a horizontal plane to a projection length of the second cutting edge on the horizontal plane is 0.618+K, -0.2≤K≤0.2.

7. The cutting unit according to claim 1, wherein each of the cutting blades is provided with a plurality of first cutters, and the plurality of first cutters are arranged on the support member at intervals in a circumferential direction of the support member.

8. The cutting unit according to claim 7, wherein each of the cutting blades is further provided with a plurality of second cutters, the plurality of second cutters are arranged on the support member at intervals in the circumferential direction of the support member, and the plurality of second cutters are positioned on one side of each of the plurality of first cutters adjacent to the rotation axis.

9. A shaver head, comprising a shaver foil used in a shaver and the cutting unit according to claim 1, wherein the shaver foil comprises an annular shaving track concentrically arranged around the rotation axis to mate with a cutting edge of the cutting unit; the annular shaving track is provided with an inner circumferential side surface, an outer circumferential side surface, and a beard inlet slot having a front edge and a rear edge when observed in the direction of movement of the cutting unit; and the beard inlet slot extends on at least one of the inner circumferential side surface and the outer circumferential side surface.

10. The shaver head according to claim 9, wherein the beard inlet slot is S-shaped, V-shaped, U-shaped, or arc-shaped.

11. An electric shaver, comprising a handheld portion and the shaver head according to claim 9, wherein the shaver head is arranged on the handheld portion.
